(19) United States
(12) Patent Application Publication
(10) Pub. No.: US 2026/0075685 A1
(43) Pub. Date: Mar. 12, 2026

(54) HIGH FREQUENCY EXCITATION HEATING EQUIPMENT AND METHOD FOR MANUFACTURING IRON CORE FOR STATIONARY EQUIPMENT

(71) Applicant: Hitachi Industrial Equipment Systems Co., Ltd., Tokyo (JP)

(72) Inventors: Chie KOBAYASHI, Tokyo (JP); Ryousuke MIKOSHIBA, Tokyo (JP); Takahiro SUMI, Tokyo (JP); Naoyuki KURITA, Tokyo (JP)

(21) Appl. No.: 19/204,789

(22) Filed: May 12, 2025

(30) Foreign Application Priority Data
Sep. 12, 2024 (JP) 2024-158614

(51) Int. Cl. H05B 6/36; H01F 41/02; H05B 6/04; H05B 6/06

(52) U.S. Cl. CPC H05B 6/36; H01F 41/0206; H05B 6/04; H05B 6/06; H05B 2206/022

(57) ABSTRACT

High frequency excitation heating equipment has a first iron core support member disposed inside the iron core, a second iron core support member disposed outside the iron core, and a fastening member fastened while insulating the first and second iron core support members, the first and second iron core support members are acyclic. A high-frequency induction coil disposed around the first iron core support member, the second iron core support member, and the iron core. A power source supplies AC power to the high-frequency induction coil. A function generator generates alternating current. A program adjuster generates a control signal that commands the function generator. At least one of the first and second iron core support members has a temperature sensor, and the measured value of the temperature sensor is input to the program controller, which feedback controls the AC power according to the measured value of the temperature sensor.

The present application claims priority from Japanese application JP2024-158614, filed on September 12, 2024, the content of which is hereby incorporated by reference into this application.

### BACKGROUND OF THE INVENTION

### 1. Field of the Invention

The present invention relates to a high frequency excitation heating equipment and method for manufacturing iron core for stationary equipment

### 2. Description of Related Art

In recent years, stationary equipment using an amorphous iron core with excellent conversion efficiency and excellent environment, as an example, an amorphous transformer, is spreading. Since the loss of the amorphous thin band is as low as 1/3 to 1/4 compared to silicon steel sheet, the amorphous iron core is constituted as a laminate of the amorphous thin band (as an example, a thickness of about 0.025 mm).

As an example, an amorphous iron core is formed by bundling and cutting a plurality of thin strips of amorphous alloy in the form of a roll wound in a hoop, laminating the cut thin strips of amorphous alloy into a rectangular core metal in a U-shape, and lapping the ends together. After that, distortion caused by bending and cutting is removed, and heat treatment is performed at 300°C to 400 °C by applying a DC magnetic field in the longitudinal direction of the iron core. This is because annealing in the magnetic field aligns the direction of the magnetic moment and the axis is fixed, so that the magnetic characteristics are improved.

The annealing treatment of amorphous iron cores currently indirectly applies heat to the iron core with warm air from an electric furnace. The furnace atmosphere is filled with inert gas to prevent oxidation of the iron core and to transmit heat with the inert gas. As an example, the structure of the furnace includes a heater unit, a circulation fan unit, and a cooling unit, which are installed in the furnace, and the gas temperature controlled by the heater unit and the cooling unit is circulated in the furnace by a circulating fan.

The method of indirectly applying heat to the iron core with warm air by such an electric furnace takes a lot of time to reach the predetermined heat treatment conditions, and in order to respond to the recent demand for reduction of power consumption, it is necessary to reduce this energy loss. JP-A-Hei 5-217775 discloses that annealing by excitation heating is performed using a jig for annealing with respect to the annealing of an amorphous iron core.

### SUMMARY OF THE INVENTION

Compared to atmospheric heating, annealing by high-frequency excitation disclosed in JP-A-Hei 5-217775 is a promising technology because it can reduce the amount of power during annealing and shorten the time required for annealing. However, despite the fact that it is a promising technology in theory, it has not been put to practical use for a long time.

Annealing by high-frequency excitation uses the heat generated by the loss. The spontaneous magnetization of magnetic materials disappears above the Curie temperature. And when the exceeding the Curie temperature is exceeded, it becomes excitation in the saturation region, and there is a problem that excitation due to overcurrent is not possible.

Therefore, an object of the present invention is to provide a high-frequency excitation heating equipment which realize practical way of annealing by high-frequency excitation and method for manufacturing iron core for stationary equipment.

An example of means for solving the problem is as follows.

High frequency excitation heating equipment with a first iron core support member disposed inside the iron core, a second iron core support member disposed outside the iron core, and a fastening member fastened while insulating the first iron core support member and the second iron core support member, the first iron core support member and the second iron core support member are acyclic, a high-frequency induction coil disposed around the first iron core support member, the second iron core support member, and the iron core, a power source that supplies AC power to the high-frequency induction coil, a function generator that generates alternating current, and a program adjuster that generates a control signal that commands the function generator, at least one of the first iron core support member and the second iron core support member has a temperature sensor, and the measured value of the temperature sensor is input to the program controller, which feedback controls the AC power according to the measured value of the temperature sensor.

In the present invention, appropriate control of high-frequency excitation is realized. And it is possible to provide a high-frequency excitation heating equipment which realize practical way of annealing by high-frequency excitation and method for manufacturing iron core for stationary equipment.

Further means and further effects of the present invention will be apparent throughout the entire specification below.

### BRIEF DESCRIPTION OF THE DRAWINGS

FIG. 1 is a configuration diagram of one embodiment of the present invention.

FIG. 2 is a control flowchart of one embodiment of the present invention.

FIG. 3 is an explanatory diagram of the control in one embodiment of the present invention.

FIG. 4 is a configuration diagram of another embodiment of the present invention.

FIG. 5 is an explanatory diagram of additional control in another embodiment of the present invention.

### DESCRIPTION OF EMBODIMENTS

Hereinafter, embodiments of the present invention will be described with referencing to drawings as necessary.

### [Embodiment 1]

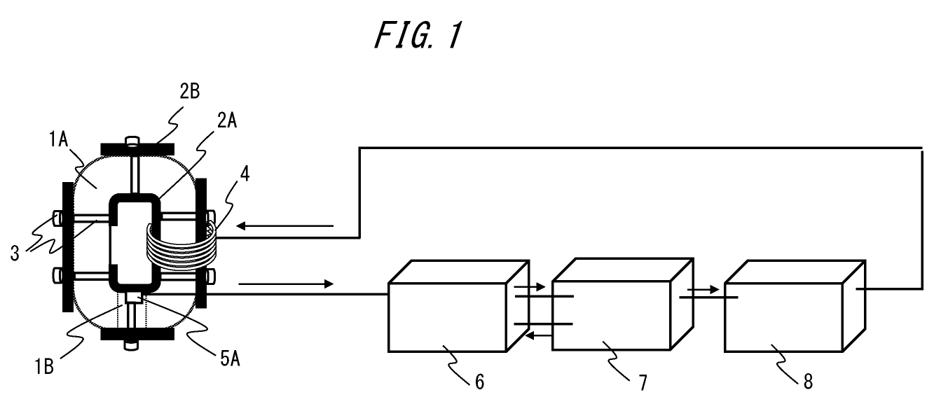

FIG. 1 is a diagram showing a configuration for annealing an amorphous iron core as an example of an iron core for stationary equipment.

The amorphous iron core 1A is sandwiched between the iron core support member 2A inside the iron core and the iron core support member 2B outside the iron core.

The iron core support member 2A inside the iron core has a discontinuous region in part and does not form a loop. In the figure, it has a C-shaped shape. It can also be said to be acyclic shape.

The iron core support member 2B outside the iron core is composed of a plurality of separated members and does not form a loop. In the figure, it consists of three flat plates.

The iron core support member 2A inside the iron core and the iron core support member 2B outside the iron core are connected by the bolt 3. The iron core support member 2B outside the iron core has a hole larger than the diameter of the bolt 3, and an insulating washer is used between the bolt 3 and the iron core support member 2B outside the iron core. Alternatively, by using the bolt 3 itself as an insulating member, conduction is avoided. As a result, the iron core is configured to prevent circulating currents as a configuration in which a loop around the metal cannot be performed.

A high-frequency excitation winding 4 is arranged to circulate the amorphous iron core 1A, the iron core support member 2A inside the iron core, and the iron core support member 2B outside the iron core, and to excite the iron core with high frequency.

A temperature sensor 5A is attached to the iron core support member 2A inside the iron core. An example is a thermocouple or the like, but other sensors may also be used. In FIG. 1, as an example, a temperature sensor 5A is attached in the vicinity of the lap joint 1B of the iron core. This is because in the portion, the temperature rise is relatively high during high-frequency excitation due to the connection resistance at the lap junction.

The information obtained from the temperature sensor 5A is input to the program adjuster 6 for feedback control. The program adjuster 6 controls a function generator 7 that gives a command regarding the excitation voltage to the power supply, and controls the power applied from the power supply 8 to the high-frequency excitation winding 4.

The temperature sensor 5A is not particularly limited to its shape or the like, but may be attached to the surface of the iron core support member 2A inside the iron core as a thin film sensor.

Alternatively, a depression may be provided on the surface of the iron core support member 2A inside the iron core inside in advance and configured so as to fit into the recess.

The instructions from the program adjuster 6 to the function generator 7 include any of the excitation voltage, excitation current, and excitation frequency. Therefore, it can also be called a command or a power command related to high-frequency power. Further, the above command for excitation voltage includes cases where the command target is any one of the excitation voltage, excitation current, excitation frequency, or a combination thereof.

Annealing by high-frequency excitation uses the heat generated by the loss. Since spontaneous magnetization of magnetic materials such as amorphous iron cores disappears above the Curie temperature, it is necessary to control the iron core temperature and perform excitation under temperature control when performing high-frequency excitation. This is because when exceeding the Curie temperature is exceeded, excitation occurs in the saturation region, and excitation is not possible due to overcurrent.

For this reason, when applying the method of JP-A-Hei 5-217775 as it is, it is necessary to perform excitation while ensuring that the Curie temperature is not exceeded, the temperature is low, and it takes time to complete the annealing work. In addition, there was an inherent possibility of incomplete annealing.

In this embodiment, the temperature is actually measured by the temperature sensor 5A, and based on the information, the program adjuster 6 provides feedback control of the excitation voltage as an example to prevent temperature exceedance and prevent excitation from being disabled. At the same time, by controlling the excitation current so as to raise the temperature as much as possible within a range that does not exceed the Curie temperature, it is possible to shorten the time to complete the annealing operation.

Thereby, it is possible to provide a method for producing a high-frequency excitation heating device and an iron core for stationary equipment suitable for practical use of annealing by high-frequency excitation.

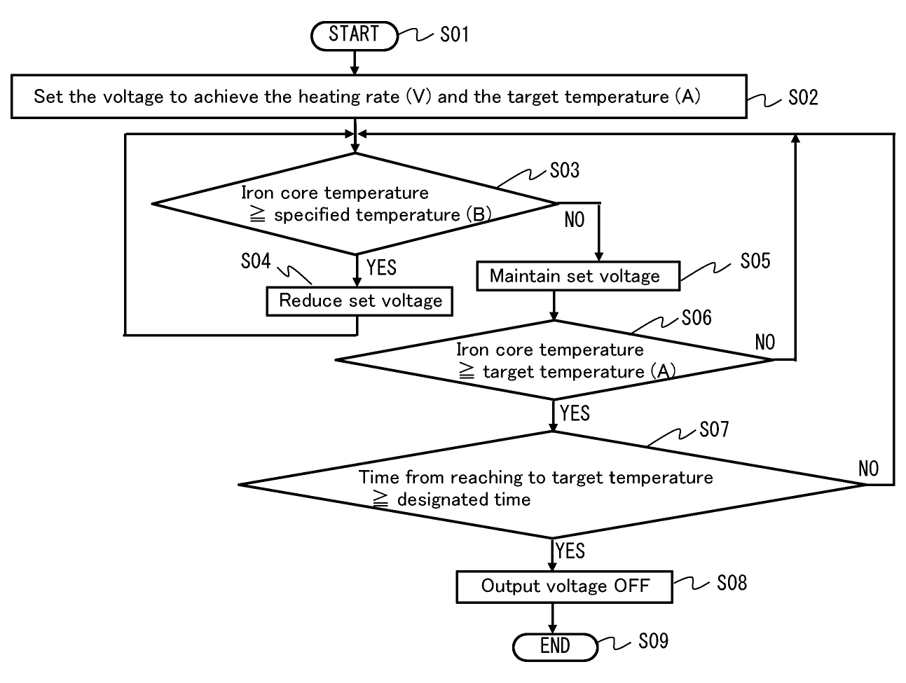

FIG. 2 is a control flowchart diagram. Control starts at S01. The voltage is controlled so that the target temperature (A) is achieved at a constant temperature rise rate (V) based on the temperature data obtained from the temperature sensor 5A at S02. In addition, it includes cases where the control target is a current or a frequency.

Determine whether the iron core temperature exceeds the specified temperature (B) with a likelihood from the upper limit value at S03. If it is exceeded, the set voltage value is reduced at S04 to prevent overheating. When the specified temperature (B) is or less, the set voltage is held at S05. Next, determine whether the iron core temperature is higher than target temperature (A) required for annealing at S06. If the target temperature is below or less, it returns to before S03 and repeats the aforementioned cycle again. If the the iron core temperature is target temperature (A) or higher, start time counting after reaching the target temperature till exceed designated time at S07. When the designated time is exceeded, the output voltage is turned off at S08, and annealing is terminated at S09.

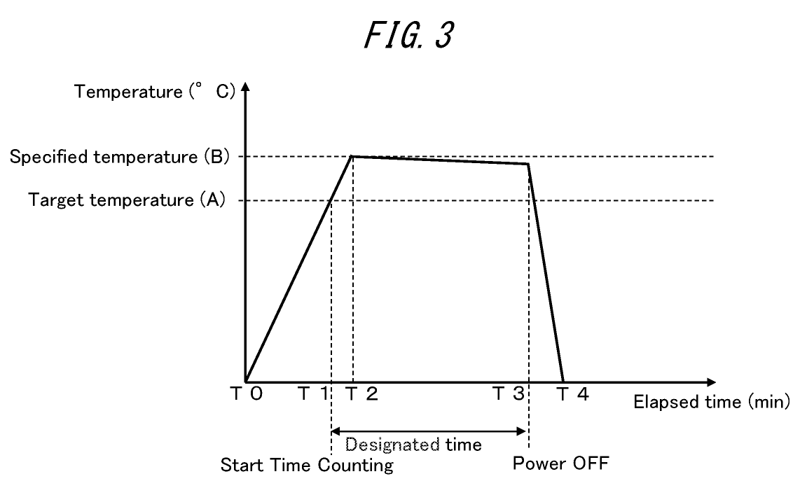

FIG. 3 is an explanatory diagram of feedback control and a profile diagram. Start annealing work at time T0. Start heating to the target temperature (A) at the heating rate (V). After the target temperature (A) is reached at time T1, time counting is started. When the time T2 is reached at the specified temperature (B), the program adjuster 6 lowers the set voltage so that it does not exceed it. Alternatively, control the set voltage. After the specified time has elapsed at or above the target temperature (A) and time T3 has been reached, the power is turned off and the temperature returns to normal at time T4.

The iron core support member 2A inside the iron core and the iron core support member 2B outside the iron core also contribute to the temperature uniformity of the iron core. And it has an acyclic shape. Thereafter, in the present embodiment, annealing is performed by feedback control in a state where the temperature is controlled.

By applying such a configuration to annealing, it is possible to maintain the iron core and move it in the work process, while continuing to provide a predetermined magnetic flux density to the iron core when a high-frequency voltage is applied, and it is possible to heat it to a predetermined temperature.

Further, when a high-frequency voltage is applied and the iron core is annealed by induction heating, the magnetic flux density on the inner peripheral side having a short magnetic path length becomes high, and the magnetic flux density on the outer peripheral side having a long magnetic path length tends to decrease. As a result, the iron loss value is also sloped at the inner and outer peripheries, which is characterized by annealing by high-frequency excitation.

Furthermore, in a wound iron core such as an amorphous iron core, there is a lap-joint portion, and the magnetic flux is characterized by a chain interchange between the thin bands of the lap-joint portion. Therefore, when high-frequency heating is performed, the inner circumference side of the lap-joint portion generates the most heat and becomes the high-temperature part. The reason why the temperature sensor 5A is attached to the inner peripheral side of the lap-joint portion is to evaluate the maximum temperature.

Furthermore, since there is a part where the iron core support member is not in contact with the iron core, a local temperature distribution is possible, and the iron loss value changes only at the part where the annular on the inner circumference side is removed. Therefore, in an iron core that has undergone high-frequency excitation using the iron core support member 2A inside the iron core and the iron core support member 2B outside the iron core as shown in FIG. 1, in addition to the inclination of the inner and outer periphery, a partial iron loss change appears. The transformer at that time is a transformer equipped with a winding iron core having a portion in which the magnetic characteristics of the inner circumference of the wound iron core are lowered by one or more in the circumferential direction.

### [Embodiment 2]

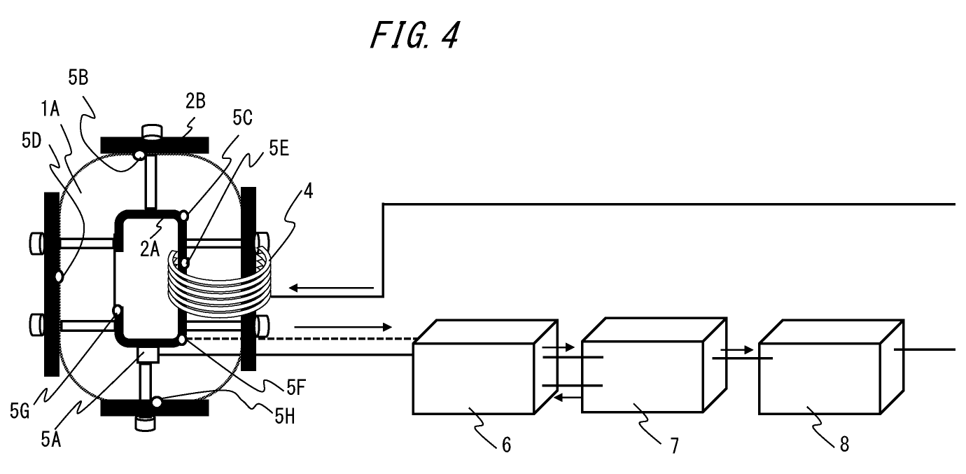

FIG. 4 is a configuration diagram in the present embodiment corresponding to FIG. 1. In the configuration of Embodiment 1, the number of sensor installation locations is numerous. Thereby, as an example, it is possible to control for preventing device destruction due to abnormal heating. Of course, it may be used to improve the high accuracy of the control of Embodiment 1.

As an example, the temperature sensor has a large number of 5A to 5H pieces, and is attached to both the iron core support member 2A inside the iron core and the iron core support member 2B outside the iron core. Of course, it is not excluded to install it only on one of the iron core support members, but it is more desirable to distribute it on both.

Values and data related to temperature from each temperature sensor are incorporated with the program controller 6. The dashed line in the figure is representative of the state in which data from temperature sensors other than 5A is also captured.

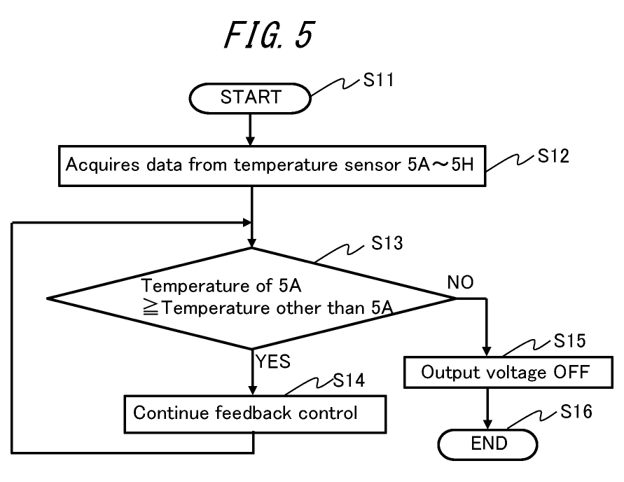

FIG. 5 is an explanatory diagram of additional feedback control in this embodiment. Along with the feedback control of FIG. 2, the control shown in FIG. 5 is executed at the same time.

The iron core support member is usually controlled at a constant tightening pressure, and when high-frequency excitation is performed, the temperature is highest on the inner circumference side of the lap-joint portion. However, if there is a defect in the tightness control during manufacturing, there is a possibility that parts other than the inner circumference of the lap-joint portion may be abnormally heated. Therefore, a temperature sensor is attached to a position that serves as the inner and outer periphery parts of the iron core, and the temperature sensor (5A) on the inner periphery side of the lap-joint portion shows a lower temperature than the temperature sensor (5B to 5H) installed in other parts, and if the other part shows a sudden increase in temperature, the power is turned off as an abnormality.

The additional feedback control in FIG. 5 starts control at S11. The temperature data of the temperature sensor 5A to 5H is acquired at S12. The temperature of the temperature sensor 5A is compared and to determine whether or not it is higher than a temperature sensor other than 5A at S13. If YES, feedback control is continued at S14 and returns to the front of S13. In the case of NO, as an abnormality occurs, the output voltage is turned off at S15 and ends at S16.

Thereby, it is possible to avoid damage to the device of the high-frequency excitation heating device due to abnormal heating. It is possible to detect fastening errors at an early stage during manufacturing, and it is possible to provide feedback to workers and review work procedures. Further, when manufacturing an iron core for stationary equipment, the occurrence of annealing failure can be avoided.

In the present invention, various variations within the scope of the above-described technical idea are also within the scope of the disclosure of the present application. For example, not only amorphous iron cores but also cases where other annealing is required are applied to the wound iron core. Further, although the above-described description uses the temperature of the iron core as a control target, for example, the magnetic flux and excitation current of each part of the iron core are observed and the control target is also included as another example.

Therefore, as long as the ideas and concepts disclosed above are used, their modifications and similar examples are also included in the scope of the present invention.

Further, aspects of this invention of the present application described using each of the above embodiments can be expressed as follows.

### <Aspect 1>

High frequency excitation heating equipment comprising;

a first iron core support member disposed inside the iron core, a second iron core support member disposed outside the iron core, and a fastening member fastened while insulating the first iron core support member and the second iron core support member, the first iron core support member and the second iron core support member are acyclic,

a high-frequency induction coil disposed around the first iron core support member, the second iron core support member, and the iron core,

a power source that supplies AC power to the high-frequency induction coil, a function generator that generates alternating current, and a program adjuster that generates a control signal that commands the function generator,

at least one of the first iron core support member and the second iron core support member has a temperature sensor, and the measured value of the temperature sensor is input to the program controller, which feedback controls the AC power according to the measured value of the temperature sensor.

### <Aspect 2>

High frequency excitation heating equipment according to Aspect 1, wherein the temperature sensor is provided corresponding to the lap-joint portion of the iron core.

### <Aspect 3>

High frequency excitation heating equipment according to Aspect 2, wherein the temperature sensor is disposed in the first iron core support member.

### <Aspect 4>

High frequency excitation heating equipment according to Aspect 3, wherein based on the measured value from the temperature sensor, the program adjuster continues to provide AC power to the high-frequency induction coil until a specified time has elapsed from the target temperature being reached.

### <Aspect 5>

High frequency excitation heating equipment according to Aspect 4, wherein when the measured value from the temperature sensor reaches the specified temperature, an instruction is given to the function generator to adjust the alternating current generated so as to reduce the output power.

### <Aspect 6>

High frequency excitation heating equipment according to Aspect 5, further comprising another temperature sensor other than the temperature sensor.

### <Aspect 7>

High frequency excitation heating equipment according to Aspect 6, wherein, additional feedback control is performed in response to the measured values of the other temperature sensor.

### <Aspect 8>

High frequency excitation heating equipment according to Aspect 7, wherein in case that the measured value of the other temperature sensor exceeds the measured value of the temperature sensor, it is judged that the device is abnormal and the output voltage is stopped.

### <Aspect 9>

Method for manufacturing iron core for stationary equipment,

wherein a first iron core support member is disposed inside the iron core, a second iron core support member is arranged outside the iron core, and the first iron core support member and the second iron core support member are fastened while insulating, the first iron core support member and the second iron core support member are acyclic, a high-frequency induction coil is disposed around the first iron core support member, the second iron core support member, and the iron core, AC power is supplied to the high-frequency induction coil to annealing the iron core, a temperature sensor is disposed on at least one of the first iron core support member or the second iron core support member, and the AC power is feedback controlled according to the measured value of the temperature sensor.

### <Aspect 10>

Method for manufacturing iron core for stationary equipment according to Aspect 9, wherein the temperature sensor is provided corresponding to the lap-joint portion of the iron core.

### <Aspect 11>

Method for manufacturing iron core for stationary equipment according to Aspect 10, wherein the temperature sensor is disposed on the first iron core support member.

### <Aspect 12>

Method for manufacturing iron core for stationary equipment according to Aspect 11, wherein AC power is supplied to the high-frequency induction coil until a designated time elapses from the target temperature is reached based on the measured value from the temperature sensor.

### <Aspect 13>

Method for manufacturing iron core for stationary equipment according to Aspect 12, wherein the AC power is reduced when the measured value from the temperature sensor reaches the specified temperature.

### <Aspect 14>

Method for manufacturing iron core for stationary equipment according to Aspect 13, wherein the measured value of another temperature sensor other than the temperature sensor is used for control.

### <Aspect 15>

Method for manufacturing iron core for stationary equipment according to Aspect 14, wherein in case that the measured value of the other temperature sensor exceeds the measured value of the temperature sensor, it is judged that the device is abnormal and the output voltage is stopped.

### <Aspect 16>

Method for manufacturing iron core for stationary equipment according to Aspect 15, wherein the iron core for the stationary equipment is an amorphous iron core.

What is claimed is:

1. High frequency excitation heating equipment comprising;
a first iron core support member disposed inside the iron core, a second iron core support member disposed outside the iron core, and a fastening member fastened while insulating the first iron core support member and the second iron core support member,
the first iron core support member and the second iron core support member are acyclic,
a high-frequency induction coil disposed around the first iron core support member, the second iron core support member, and the iron core,
a power source that supplies AC power to the high-frequency induction coil, a function generator that generates alternating current, and a program adjuster that generates a control signal that commands the function generator,
at least one of the first iron core support member and the second iron core support member has a temperature sensor, and the measured value of the temperature sensor is input to the program controller, which feedback controls the AC power according to the measured value of the temperature sensor.

2. High frequency excitation heating equipment according to claim 1, wherein the temperature sensor is provided corresponding to the lap-joint portion of the iron core.

3. High frequency excitation heating equipment according to claim 2, wherein the temperature sensor is disposed in the first iron core support member.

4. High frequency excitation heating equipment according to claim 3, wherein based on the measured value from the temperature sensor, the program adjuster continues to provide AC power to the high-frequency induction coil until till a specified time has elapsed from the target temperature being reached.

5. High frequency excitation heating equipment according to claim 4, wherein when the measured value from the temperature sensor reaches the specified temperature, an instruction is given to the function generator to adjust the alternating current generated so as to reduce the output power.

6. High frequency excitation heating equipment according to claim 5, further comprising another temperature sensor other than the temperature sensor.

7. High frequency excitation heating equipment according to claim 6, wherein, additional feedback control is performed in response to the measured values of the other temperature sensor.

8. High frequency excitation heating equipment according to claim 7, wherein in case that the measured value of the other temperature sensor exceeds the measured value of the temperature sensor, it is judged that the device is abnormal and the output voltage is stopped.

9. Method for manufacturing iron core for stationary equipment,
wherein a first iron core support member is disposed inside the iron core, a second iron core support member is arranged outside the iron core, and the first iron core support member and the second iron core support member are fastened while insulating,
the first iron core support member and the second iron core support member are acyclic,
a high-frequency induction coil is disposed around the first iron core support member, the second iron core support member, and the iron core,
AC power is supplied to the high-frequency induction coil to annealing the iron core,
a temperature sensor is disposed on at least one of the first iron core support member or the second iron core support member, and the AC power is feedback controlled according to the measured value of the temperature sensor.

10. Method for manufacturing iron core for stationary equipment according to claim 9, wherein the temperature sensor is provided corresponding to the lap-joint portion of the iron core.

11. Method for manufacturing iron core for stationary equipment according to claim 10, wherein the temperature sensor is disposed on the first iron core support member.

12. Method for manufacturing iron core for stationary equipment according to claim 11, wherein AC power is supplied to the high-frequency induction coil until a designated time elapses from the target temperature is reached based on the measured value from the temperature sensor.

13. Method for manufacturing iron core for stationary equipment according to claim 12, wherein the AC power is reduced when the measured value from the temperature sensor reaches the specified temperature.

14. Method for manufacturing iron core for stationary equipment according to claim 13, wherein the measured value of another temperature sensor other than the temperature sensor is used for control.

15. Method for manufacturing iron core for stationary equipment according to claim 14, wherein in case that the measured value of the other temperature sensor exceeds the measured value of the temperature sensor, it is judged that the device is abnormal and the output voltage is stopped.

16. Method for manufacturing iron core for stationary equipment according to claim 15, wherein the iron core for the stationary equipment is an amorphous iron core.
